(19) United States
(12) Patent Application Publication
(10) Pub. No.: US 2007/0299780 A1
(43) Pub. Date: Dec. 27, 2007

(54) METHODS, APPARATUSES AND COMPUTER PROGRAM PRODUCT FOR PROVIDING A CONTENT SUPERDISTRIBUTION SYSTEM

(75) Inventors: Marko Vanska, Shanghai (CN); Hong Qian, Beijing (CN); Tom Kan, Chaoyang (CN); John Chang, Taipei City (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/740,613

(22) Filed: Apr. 26, 2007

Related U.S. Application Data
(60) Provisional application No. 60/795,029, filed on Apr. 26, 2006.

(51) Int. Cl. H04L 9/00

(52) U.S. Cl. 705/59

(57) ABSTRACT

A method and system are provided for transferring content and one or more tokens between a server and one or more terminals. The method and system consists of a first terminal capable of connecting to a server and enabling the purchase of content and one or more tokens from the server. The server stores the content and token(s) on behalf of a user. The first terminal is capable of downloading the content and the token(s) stored at the server. Alternatively, a second terminal is capable of automatically downloading the content and the token(s) from the server upon connecting to a network.

### CROSS REFERENCE TO A RELATED APPLICATION

The present application claims priority to U.S. Provisional Application No. 60/795,029 filed Apr. 26, 2006, the contents of which are incorporated by reference herein in their entirety.

### TECHNOLOGICAL FIELD

Embodiments of the present invention relate generally to distribution of content and tokens between mobile electronic devices and more particularly, relate to methods, apparatuses and a computer program product for distributing content and tokens from a content distributor to mobile electronic devices and/or between electronic devices.

### BACKGROUND

In recent times digital media is becoming increasingly common and important. With the advent of personal computers and the like, digital media files are very easy to copy an unrestricted number of times without any degradation in the quality of subsequent copies. Given the widespread use of the Internet and files sharing mechanisms, large scale transfer of copyrighted digital media files is now a simple task. To curtail the expansive distribution of copyrighted digital media files between electronic devices and ensure that the owner of the digital media collects a fee for each copy made of a digital work, many content distributors employ Digital Rights Management (DRM) which may be used to control access to content such as software, music, images, movies, or other digital media. DRM allows artists who create the digital media to reap the benefits of their labor. By applying DRM technologies to digital media, the digital media may be prevented from being copied or disseminated other than by a paying customer. In a typical scenario, DRM dictates that the digital media be encrypted so that it may not be used or copied by unauthorized users commonly referred to as pirates. However, when an unauthorized user pays the requisite fee for the digital media, to the content distributor, an encryption key is often provided to the user so that the digital media can be decoded and activated.

To obtain the rights to use and/or copy digital media from content distributors, consumers may typically access an Internet site of the content distributor and pay the requisite fee for the digital media file(s) desired by the consumer. The purchased digital media(s) files may then be downloaded to electronic devices such as computing devices which include personal computers, laptop computers, mobile telephones, personal digital assistants and the like. For example, the consumer may access an Internet music store where he either has an account set up or establishes an account to facilitate purchases of music from the online store. The consumer may then download the music to his personal computer or a mobile device such as an MP3 player. Since it is currently common that consumers require access to the Internet to purchase and download desired digital media from a content distributor, it is oftentimes very difficult and cumbersome for the content distributor to facilitate the purchase and download of digital media when the consumer is not connected to the Internet (i.e., offline). In this regard, the content distributor may lose monetary gains associated with the purchase and download of the desired digital media due to the lack of an Internet connection by the consumer. Additionally, given that consumers normally require an Internet connection to purchase and download digital media, it is difficult and cumbersome for the content distributor to monitor and obtain payment for an offline transfer of digital media between a consumer who previously purchased and downloaded the digital media (from the content distributor) and another consumer.

Given the above described difficulties, there is an existing need to establish a mechanism in which digital media files may be easily purchased and downloaded from a content distributor by a consumer even when the consumer's electronic device (e.g. terminal), which will use the digital media, is offline, e.g., not connected to the Internet. Additionally, there is a need to develop a mechanism which allows the content distributor to easily receive payment for digital media that is transferred offline between a terminal of a consumer, who previously downloaded and purchased the digital media from the content distributor, and another terminal of a consumer who desires to have the digital media installed on his electronic terminal.

### BRIEF SUMMARY

Methods, apparatuses and a computer program product code are therefore provided which enable consumers or users desiring content subject to Digital Rights Management to purchase and download the content even when terminals that will use the content are offline, e.g., not connected to the Internet. Additionally, embodiments of the invention enable content previously installed on one terminal to be transmitted offline from the Internet to another terminal desiring the content. According to embodiments of the present invention, the content distributor is able to receive payment for the subsequent offline transmission of content, so long as a user (or gift-giver) has tokens which are used for payment of the content. Once the content distributor receives the tokens as payment for the content from the user, the content distributor can pay the owner of the content a fee or royalty for allowing its subscribers (i.e., users) to utilize the content.

Additionally, in one exemplary embodiment, a method and a system for transferring at least one of content and one or more tokens is provided. The method and system include connecting to a server and purchasing content as well as one or more tokens from the server. The method further includes storing the content and the one or more tokens at the server on behalf of a user and automatically downloading the content and the one or more tokens purchased from the server.

In another exemplary embodiment, a method and system for transferring content and one or more tokens is provided. The method and system include communicating with a server and purchasing one or more tokens stored at the server. The method and system further includes downloading the one or more tokens from the server and generating one or more copies of the content. The method and system further includes using the one or more tokens against the value of the one or more copies of the content and writing data corresponding to the one or more copies of content into the used one or more tokens. The method and system further includes transferring the one or more copies of the content.

In another exemplary embodiment, a method and a system for transferring content and one or more tokens is provided. The method and system include purchasing and downloading the one or more tokens from a server and generating one or more copies of the content. The method and system further include locking the one or more copies of content, and transferring one or more locked copies of content.

In another exemplary embodiment of the present invention, a method and a system for transferring tokens from a first terminal to a second terminal are provided. The method and system include purchasing and downloading, at a first terminal, one or more tokens from a server, storing the one or more tokens on the first terminal and transferring the one or more tokens to a second terminal. In another exemplary embodiment of the present invention a method and system for transferring tokens and content are provided. The method and system include connecting to and purchasing one or more tokens from a server. The method and system further include downloading and storing the one or more tokens purchased from the server and transmitting the one or more tokens.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a mobile terminal according to an exemplary embodiment of the invention;

FIG. 2 is a schematic block diagram of a wireless communications system according to an exemplary embodiment of the invention;

FIG. 3 is a schematic block diagram of an entity capable of operating as a content/token server, in accordance with exemplary embodiments of the invention;

FIG. 4A illustrates a flowchart of an exemplary method of downloading content and tokens from a website or kiosk, in accordance with an exemplary embodiment of the invention;

FIG. 4A illustrates a system in which a user downloads content and tokens from a website or kiosk, in accordance with an exemplary embodiment of the invention.

FIG. 5 illustrates a flowchart of an exemplary method of transferring content previously installed at a mobile terminal to another mobile terminal as a gift, in accordance with an exemplary embodiment of the invention;

FIG. 5A illustrates a system in which a mobile terminal is capable of transferring content previously installed to another mobile terminal as a gift, in accordance with an exemplary embodiment of the invention;

FIG. 6 illustrates a flowchart of an exemplary method of receiving content, at one mobile terminal, wherein the content is stored at another mobile terminal, in accordance with an exemplary embodiment of the invention;

FIG. 6A illustrates a system in which a mobile terminal is capable of receiving content stored at another mobile terminal, in accordance with an exemplary embodiment of the invention;

FIG. 7 illustrates a flowchart of an exemplary method of transferring tokens from a mobile terminal to another mobile terminal, in accordance with an exemplary embodiment of the invention; and

FIG. 7A illustrates a system in which a mobile terminal is capable of transferring tokens to another mobile terminal, in accordance with an exemplary embodiment of the invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

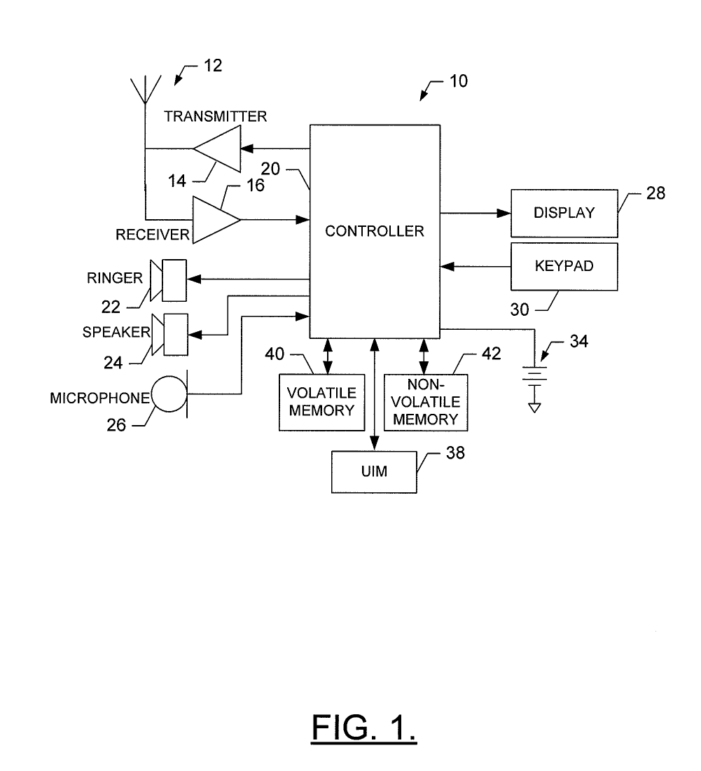

FIG. 1 illustrates a block diagram of a mobile terminal 10 that would benefit from embodiments the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), MP3 or the like players, pagers, mobile televisions, laptop computers and other types of voice and text communications systems, can readily employ the present invention. Also, near field communication (NFC) devices like Nokia 6131NFC can be used. In NFC users can by touching devices activate the distribution of the content either through other radio(s) or cable(s).

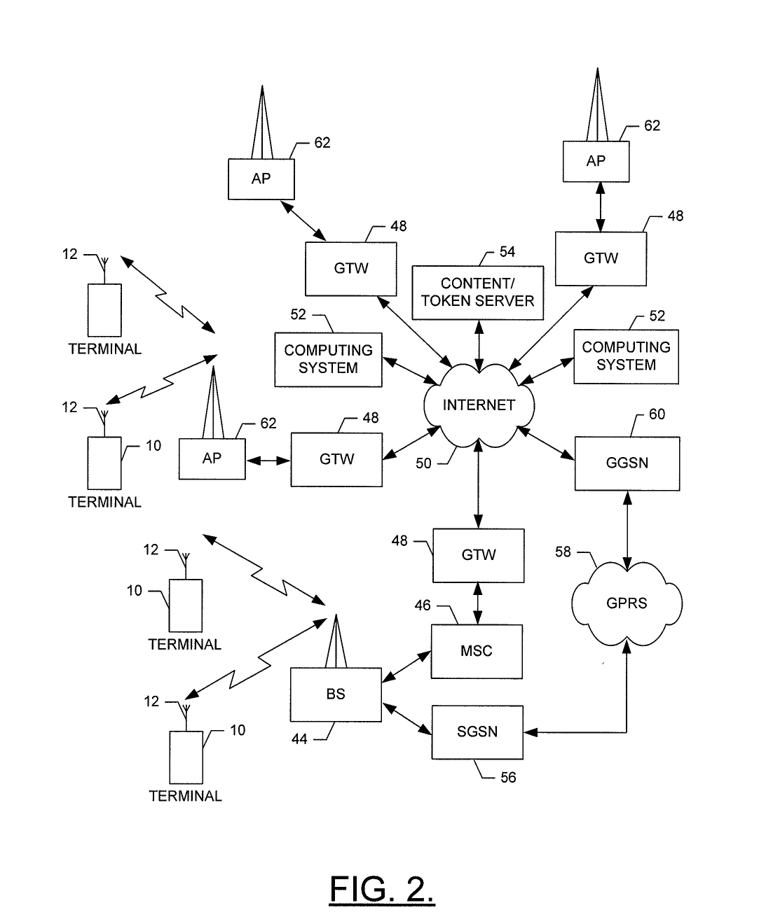

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries. For example, network devices as shown in FIG. 2 and described below, or indeed, any electronic device involving hardware and software elements would similarly benefit from the present invention. Accordingly, the present invention should not be construed as being limited to applications in the mobile communications industry.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 includes the conventional numeric (0-9) and related keys (#, *), and other keys used for operating the mobile terminal 10. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

Referring now to FIG. 2, an illustration of one type of system that would benefit from embodiments of the present invention is provided. The system includes a plurality of network devices, any of which may employ embodiments of the present invention. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), content/token server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or content/token server 54 may be coupled to the mobile terminal 10 via the Internet 50, SGSN 56 and GGSN 60. In this regard, devices such as the computing system 52 and/or content/token server 54 may communicate with the mobile terminal 10 across the SGSN 56, GPRS core network 58 and the GGSN 60. By directly or indirectly connecting mobile terminals 10 and the other devices (e.g., computing system 52, content/token server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA), very fast infrared (VFIR) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the content/token server 54, and/or any of a number of other devices, to the Internet 50, the mobile terminals 10 can communicate with one another, the content/token server 54, etc., to thereby carry out various functions of the mobile terminals 10, such as to transmit data, content or the like to, and/or receive content, data or the like from, the content/token server 54. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA, VFIR or any of a number of different wireline or wireless communication techniques, including serial, universal serial bus (USB), Ethernet, wireless Ethernet (WiFi), LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA, VFIR or any of a number of different wireline or wireless communication techniques, including serial, USB, Ethernet, WiFi, LAN, WLAN, WiMAX and/or UWB techniques.

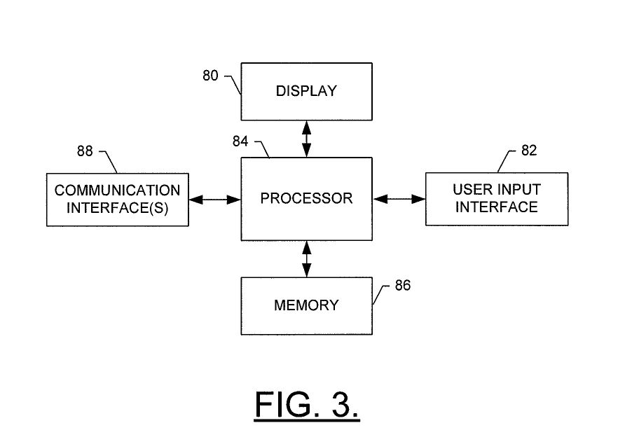

Referring now to FIG. 3, a block diagram of an entity capable of operating as a content/token server 54, is shown in accordance with one embodiment of the present invention. The entity capable of operating as a content/token server 54 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 3, the entity can include a processor 84 connected to a memory 86. The memory can comprise volatile and/or non-volatile memory, and typically stores content, data or the like. For example, the memory typically stores content transmitted from, and/or received by, the entity. Also for example, the memory typically stores client applications, instructions or the like for the processor to perform steps associated with operation of the entity in accordance with embodiments of the present invention. As explained below, for example, the memory can store client application(s).

As described herein, the client application(s) may each comprise software operated by the respective entities. It should be understood, however, that any one or more of the client applications described herein can alternatively comprise firmware or hardware, without departing from the spirit and scope of the present invention. Generally, then, the content/token server 54 can include one or more logic elements for performing various functions of one or more client application(s). As will be appreciated, the logic elements can be embodied in any of a number of different manners. In this regard, the logic elements performing the functions of one or more client applications can be embodied in an integrated circuit assembly including one or more integrated circuits integral or otherwise in communication with a respective network entity (i.e., computing system, content/token server, etc.) or more particularly, for example, a processor 84 of the respective network entity. The design of integrated circuits is by and large a highly automated process. In this regard, complex and powerful software tools are available for converting a logic level design into a semiconductor circuit design ready to be etched and formed on a semiconductor substrate. These software tools automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the memory 86, the processor 84 can also be connected to at least one interface or other means for displaying, transmitting and/or receiving data, content or the like. In this regard, the interface(s) can include at least one communication interface 88 or other means for transmitting and/or receiving data, content or the like. For example, the communication interface(s) can include a first communication interface for connecting to a first network, and a second communication interface for connecting to a second network. In addition to the communication interface(s), the interface(s) can also include at least one user interface that can include one or more earphones and/or speakers, a display 80, and/or a user input interface 82. The user input interface, in turn, can comprise any of a number of devices allowing the entity to receive data from a user, such as a microphone, a keypad, a touch display, a joystick, image capture device (e.g., digital camera) or other input device.

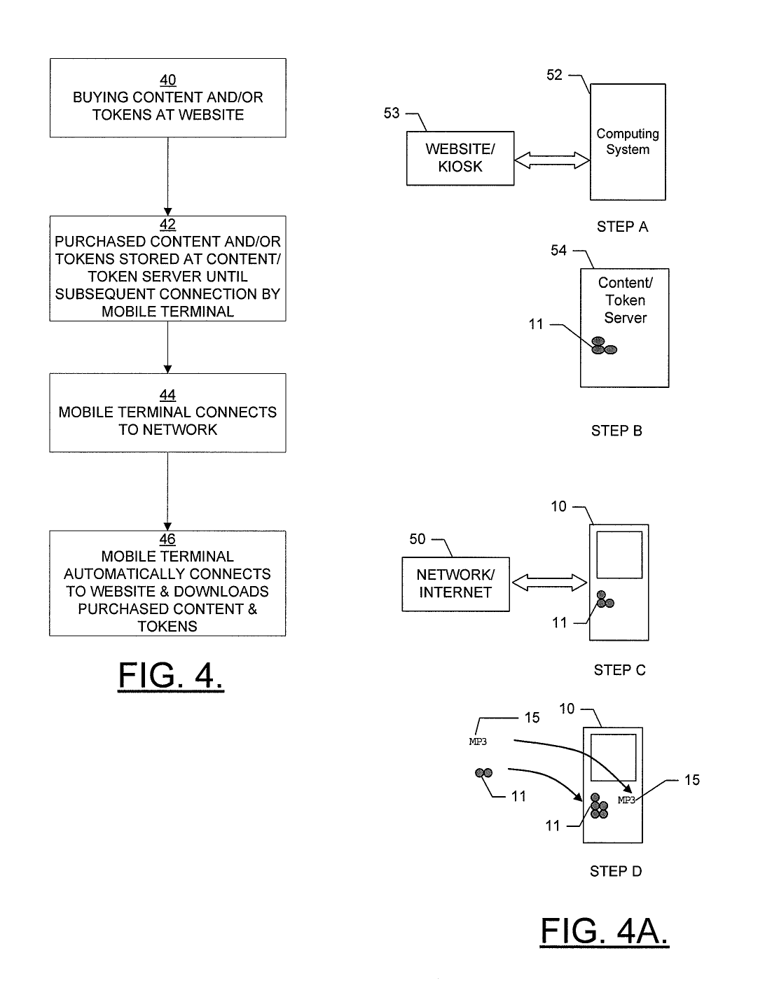

An exemplary embodiment of the invention will now be described with reference to FIGS. 4 and 4A, in which a user downloads content 15 and tokens 11 from a content distributor, such as a website or kiosk 53 operated by the content distributor, while the user's mobile terminal which will use the content 15 and tokens 11, is not connected to the Internet. More particularly, a user may communicate with a content distributor via a network (e.g. Internet 50) and purchase content, subject to Digital Rights Management, at a website or kiosk 53 of the content distributor. The content may be, but is not by any means limited to, audio data (e.g. MP3 files), video data, text, images, and animations. While connected to the content distributor's website or kiosk 53, the user may also purchase virtual tokens (hereinafter “tokens”). (See block 40; See also Step A) As is well known by those skilled in the art, the tokens 11 may be used as a form of digital payment for e-commerce transactions. For example, the tokens may be used against the value of content. The content and/or tokens may be purchased by the user via a variety of mechanisms such as by using SMS, or premium SMS. The user may choose to pay for the content 15 and/or tokens 11 by using a number of options including but not limited to paying by credit cards, prepaid cards, soft money, soft-coins (e.g. Qcoins) and the like. In one exemplary embodiment, if the user has an NFC device in which a digital credit card or any other payment card information is mounted (or stored) and/or activated, then the user can use the digital credit card or other payment card information in payment. (See e.g., WO 2005081183, WO 2006095212, and U.S. Patent Application Publication No. 2007-0001852 (each of which are assigned to the Applicant of the present application, i.e., Nokia Corp.), the contents of which are herein incorporated by reference) The purchased content and/or tokens may be originally stored at the content/token server 54 of the content distributor which is accessible via the content distributor's website. (See block 42; See also Step B) In instances in which the user's mobile terminal 10 accesses the content/token server 54 and has paid for the content and additional tokens, the content 15 and tokens 11 are downloaded to the mobile terminal. As discussed above, the mobile terminal 10 may connect to the network in accordance with techniques such as, for example, RF, BT, IrDA, VFIR, or any of a number of different wireline or wireless communication techniques, including but not limited to serial, USB, Ethernet, WiFi, LAN, WLAN, WiMAX and/or UWB techniques. Once downloaded by the mobile terminal 10, the content and/or tokens may then be stored at a memory of the mobile terminal 10. The user may initially connect to the content/token server 54, not by means of the mobile terminal, but by another computing device, such as computing system 54 or a personal computer (PC). In this instance, the user can purchase content 15 and additional tokens via the PC and the content 15 and tokens 11 can be stored by the content/token server 54 for the user. Thereafter, once the mobile terminal connects to the network, the mobile terminal is automatically directed to the content/token server 54 which downloads the previously purchased content and tokens to the mobile terminal. (See blocks 44 and 46; See also Step C & Step D).

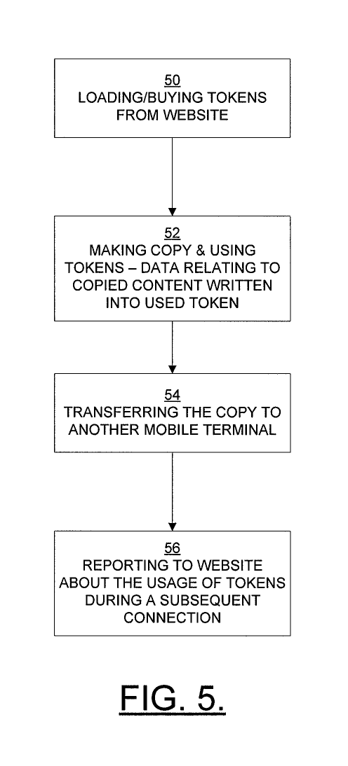

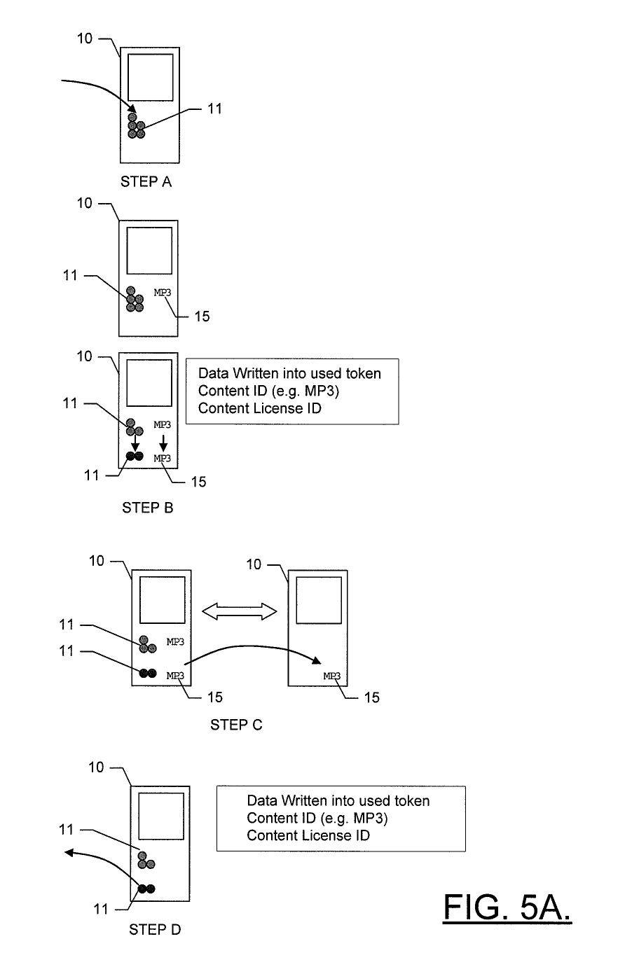

Referring now to FIGS. 5 and 5A, FIGS. 5 and 5A display an exemplary embodiment of the invention capable of transferring content, previously stored at one terminal, to another terminal as a gift while both terminals are offline. With regards to FIGS. 5 and 5A, a user of a first mobile terminal 10 may communicate with a content/token server of the content distributor so as to purchase and download tokens. (See block 50; See also Step A). The user may make one or more copies of content 15 (e.g. MP3 file(s)) that was previously downloaded and stored on the first mobile terminal 10. In order to make the copy or copies of content 15, the user may use a token(s) 11 against the value of the content 15 as indicated by the DRM associated with the content. That is to say, the tokens 11 serve as a virtual indication of the monetary value of the content 15. As such, the number of unused or available tokens stored on the first mobile terminal are decreased based on the value of the copied content. Data identifying the copied content 15 is written into a used token(s). For instance, if the content 15 copied is a music file, such as an MP3 file, data associated (e.g. Content ID and Content License ID) with the music file may be written into tokens 11 used to cover the value of the music file which was copied. (See block 52; See also Step B) (In one exemplary embodiment of the present invention, identification of the MP3 contents and identification relating to where to store tokens are important for the super distribution system. As such, a TAG (which includes but is not limited to a type of metadata involving the association of descriptors with objects and the like) is used to describe the MP3 audio file. The TAG may include, but is not limited to, information relating to artist, title, album, publishing year, genre and the like. There may also be some extra space in the TAG for comments. The TAG is 128 bytes long (but may be any other suitable byte size) and is located at the very end of the audio data, i.e., at the end of the audio data in the MP3 audio file. There are at least three fields, such as for example, Content ID, License ID and TokenNumber that can be stored in the extra space of the TAG. The Content ID is unique and is used to identify the owner of the MP3 and the License ID is used for encryption, whereas the TokenNumber is used to store a number of tokens.) Thereafter, the user may transfer the copied content, which is stored on a memory of the first mobile terminal 10, to a second mobile terminal 10. (See block 54; See also Step C) The transfer of the copied content may occur even when the first and second mobile terminals are offline and have no backbone connection to the Internet. The mobile terminals 10 described herein may comprise a gift key, gift button or gift soft key to effectuate the transfer of copied content. For example, when a user of a first mobile terminal 10 desires to transfer copied content 15 (e.g., a music file) to a second mobile terminal 10, the user may touch the key or button and the number of tokens 11 corresponding to the value of the copied content stored on the first mobile terminal is decreased. More particularly, after the content 15 (e.g., music file) is selected by the user of the first mobile terminal, touching the gift button will enable, activate or turn on a short range radio device of the first mobile terminal and establish a connection with another device such as, for example, the second mobile terminal (if a number of terminals are around or in the physical proximity of the user of the first mobile terminal, this user can select another user of another terminal with whom to share the content 15 (e.g., music file) by clicking, for example, the gift key, gift button, or gift soft key again) After the content 15 (e.g., music file) has been successfully distributed to the second mobile terminal, the tokens are reduced from a memory of the first mobile terminal.

In one exemplary embodiment of the present invention, the initiation of transfer may occur by using radio-frequency identification (RFID). (For examples of initiation of transfers of data using RFID see e.g. EP1712047, and U.S. Pat. No. 6,892,052, assigned to the assignee of the present application i.e., Nokia Corp., the contents of which are incorporated herein in their entirety by reference) Thereafter, the copied content is transferred to the second terminal 10. As previously pointed out the mobile terminals 10 can communicate with one another while they are disconnected from the Internet, by using a number of known communication techniques, including but not limited to serial, USB, Bluetooth, Ethernet, wireless Ethernet (i.e., WiFi), cellular, infrared (IrDA) and VFIR.

During a subsequent connection with the content/token server 54, the first mobile terminal 10 (from which the content 15 was copied) reports the usage of the tokens 11 against the value of the copied content to the content distributor's server. (See block 56; See also Step D) For example, data written into used tokens is transmitted along with the tokens to the content/token server of the content distributor. The data written (e.g. Content ID (e.g., MP3 file) and Content License) into the used tokens 11 identifies the copied content 15. Given that the content distributor receives the information regarding the usage of the tokens and since data written into the used tokens identifies the content transferred to the second mobile terminal 10, the content distributor, is able to pay royalties to the owner of the content (e.g. artist of the music file or copyright holder of the music file) or otherwise appropriately account for usage of the content.

In an exemplary embodiment, one mobile terminal and/or one content/server is designed such that upon the establishment of a subsequent network connection, e.g., upon subsequently establishing Internet access, the mobile terminal (for example MP3 player) is automatically directed to the content/token server and the status of each token or the used token(s) is provided to the content/token server. The mobile terminal may establish the network connection and be automatically directed to the content/token server by using a near field communication RFID capability of the mobile terminal. (See WO 2005038678 (assigned to the Applicant of the present application, i.e., Nokia Corp., the contents of which are herein incorporated by reference in their entirety), which describes mobile terminals using NFC RFID capabilities)

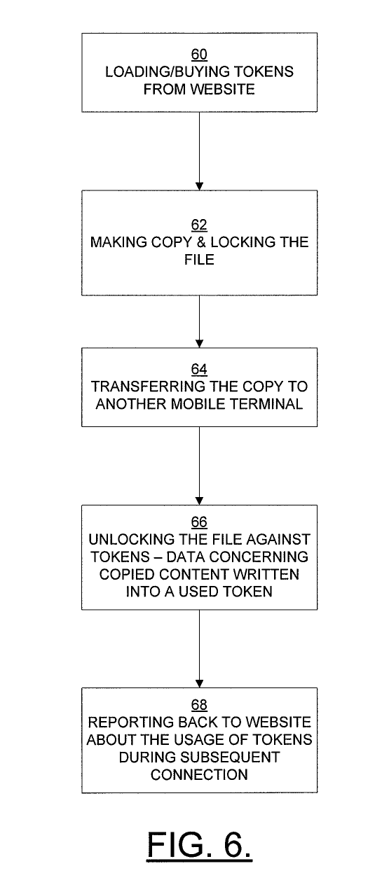

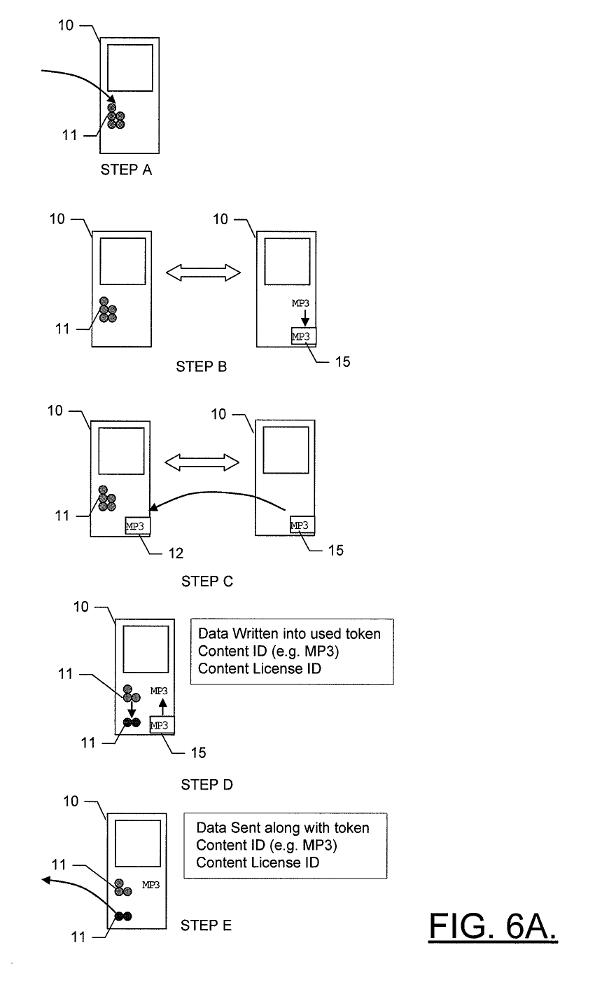

Reference will now be made to FIGS. 6 and 6A in which FIGS. 6 and 6A show an exemplary embodiment of the invention in which a mobile terminal is capable of receiving content stored at another mobile terminal when the mobile terminals are offline. First, the user of a first mobile terminal 10 communicates with the content distributor via a connection with the content/server 54 of the content distributor in order to purchase and download tokens 11 from the Service Provider's server (See block 60; See also Step A). The downloaded tokens may be paid for by using SMS, premium SMS, credit cards, ATM/Debit cards, prepaid cards, soft money, soft coins (e.g. Qcoins) and the like. Additionally, the downloaded tokens 11 may be stored on a memory of first mobile terminal 10. The first mobile terminal 10 may send a request for content (e.g. MP3 file) subject to DRM to a second mobile terminal 10 via an offline connection (e.g., non-Internet related connection). The second mobile terminal 10 makes a copy of the requested content and locks, encrypts or otherwise protects the resulting copy. (See block 62; See also Step B) Thereafter, the second mobile terminal 10 transfers the protected copy to the first mobile terminal 10. (See block 64; See also Step C) The first mobile terminal then pays to unlock the copy with the tokens 11. In this regard, after the first mobile terminal 10 decreases the number of unused or available tokens stored therein corresponding to the value of the content file, the protected copy can be unlocked by the first mobile terminal. In one embodiment, the encryption key to unlock the protected copy is provided to the first mobile terminal 10, after the tokens are allocated to pay for the protected copy. As before, data associated with the copied content file received by the first mobile terminal 10 is written into a used token(s). (See block 66; See also Step D) For example, data written (Content ID (e.g., MP3 file) and Content License) into used tokens may identify the content 15 such as a particular MP3 file. The mobile terminals 10 can communicate with one another while they are disconnected from the Internet, by using a number of known communication techniques, including but not limited to serial, USB, Bluetooth, Ethernet, wireless Ethernet (i.e., WiFi), cellular, infrared (IrDA) and VFIR.

During a subsequent connection to the content/token server (e.g., via a connection to the content distributor's website or kiosk), the first mobile terminal 10 reports the usage of the tokens to the server. (See block 68; See also Step E). Since the content distributor receives the information regarding the usage of the tokens and given that data written into the used tokens identifies the content transferred to the first mobile terminal 10, the content distributor is able to pay royalties and otherwise account to the owner of the content.

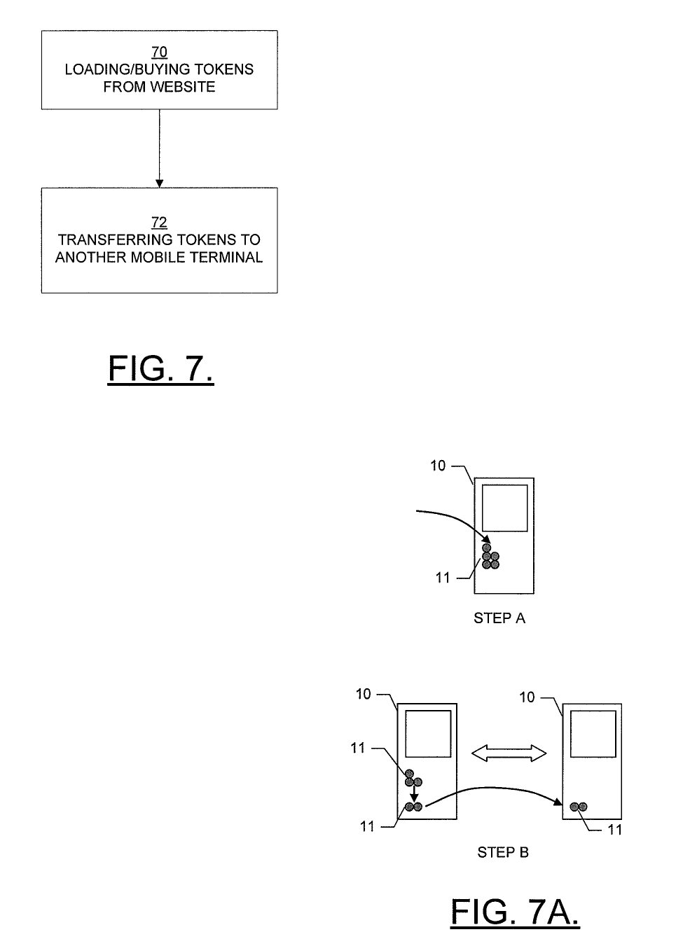

Referring now to FIGS. 7 and 7A, FIGS. 7 and 7A show an exemplary embodiment of the present invention in which a terminal is capable of transferring tokens 11 to another terminal while both of the terminals are offline. The user of a first mobile terminal 10 communicates with the content distributor via a connection to a content/token server 54 of the content distributor to purchase and download tokens from the content distributor's website (See block 70; See also Step A). Additionally, the downloaded tokens 11 may be stored on a memory of the first mobile terminal 10. The first mobile terminal 10 may transmit one or more of the purchased tokens 11 to a second mobile terminal 10 even when both the first and second mobile terminals 10 are disconnected from the Internet and are otherwise offline. (See block 72; See also Step B) The transfer of the purchased tokens may occur by using a number of known communication techniques, including but not limited to serial, USB, Bluetooth, Ethernet, wireless Ethernet (i.e., WiFi), cellular, infrared (IrDA) and VFIR. The second mobile terminal 10 is able to use the received token(s) against the value of content 15 that may be subsequently obtained from another mobile terminal 10 or by downloading the content 15 from the content distributor's website or kiosk. Additionally, and/or alternatively, the second mobile terminal 10 may transfer the tokens that it received from the first mobile terminal to another mobile terminal 10. As will be apparent when considering the embodiment of FIGS. 7 and 7A with prior embodiments, content 15 can also be transferred along with the tokens 11 from the first mobile terminal to the second mobile terminal so long as one of the first or second mobile terminals expends one or more of its tokens (including, in one embodiment, one or more of the transferred tokens) to pay for or in exchange for the transfer of the content.

It should be understood that each step of the flowcharts illustrated in FIGS. 4, 5, 6, and 7 can be implemented by computer program instructions. These computer program instructions may be loaded onto a computer or other programmable apparatus such as the mobile terminals and/or the content/token server, to produce a machine, such that the instructions which execute on the computer or other programmable apparatus create means for implementing the functions specified in the flowchart step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart step(s). The computer program instructions may also be loaded onto a computer or other programmable apparatus to produce a computer implemented process such that the instructions which execute on the computer or other programmable apparatus provide steps for implementing the functions specified in the flowchart step(s).

Accordingly, steps of the flowchart support combinations of means for performing the specified functions, combinations of steps for performing the specified functions and program instruction means for performing the specified functions. It will be understood that each step of the flowchart, and combinations of steps in the flowchart, can be implemented by special purpose hardware-based computer systems which perform the specified functions or steps, or combinations of special purpose hardware and computer instructions.

While the foregoing embodiments discuss the purchasing of content and tokens from a common content/token server 54, content and tokens can be obtained from separate sources. As such, the system of one embodiment includes one or more content servers and one or more token servers, each of which is generally represented by FIG. 3.

In addition to the content which is usually associated with an MP3 file, video, wall paper or other digital material may be associated with the MP3 type content. As such, this additional content may also be copyright material from which users need to pay for the rights of its usage. In an exemplary embodiment of the present invention, some of the tokens may also be used against this additional material when they are delivered between the terminals. Thus, token usage may relate to the delivery of this additional content. The additional content may have an ID which is included in a field of a TAG, described above. Additionally or alternatively, the additional content may have an ID that is embedded in a Content ID.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

For example, in an exemplary embodiment in which the mobile terminals 10 comprise a gift key, gift button or gift soft key to effectuate the transfer of copied content, the gift key, gift button or gift soft key which needs to be selected to effectuate the transfer of copied content is visible to the user of the mobile terminal based on a function or activity the user is expected to select, which can be carried out by using LED techniques. In an another exemplary alternative embodiment, it is beneficial that when the user of the mobile terminal 10, which has the potential to share content to different users of other terminals, knows when it is time to share or give a gift (i.e., share or transfer content) to one or more of the users of the other terminals. In this regard, the user of the mobile terminal having the content may receive an indication on his/her mobile terminal indicating that it is possible to share or transfer content to one or more other terminals.

In an alternative exemplary embodiment, the user of the mobile terminal 10, might include a calendar and/or notes or the like with specific information relating to, for example birthdays, anniversaries, appointments, meeting schedules, or other important times, dates and the like, and once these times, dates, etc, occur, the user of the mobile terminal will be notified by the mobile terminal that now it is time for transferring, sharing, i.e., giving a gift of content to one or more users of other terminals. Also, when users of other terminals are around or in the physical proximity of the user of the mobile terminal 10, the user of the mobile terminal 10 will be informed (via mobile terminal 10) that now it is possible to share i.e., give the gift to one or more of the users of the other terminals. The sharing, i.e., gifting or transferring of content from the mobile terminal 10 to users of other terminals in the physical proximity of mobile terminal 10, may take place over a Bluetooth connection or other suitable short range communication.

In another exemplary embodiment of the present invention, a specific music file, i.e., a song that the user of the mobile terminal is listening to may trigger an option on his/her mobile terminal for sharing i.e., giving a gift (e.g., the song) to another user of a terminal and an option to select the gift key, gift button or gift soft key is shown to the user of the mobile terminal, for example on display 28. In an alternative exemplary embodiment, the display 28 may be a touch display which may enable different icons to be shown to the user of the mobile terminal, in which the user may select.

What is claimed:

1. A method, comprising:
purchasing one or more tokens from a server while offline such that the one ore more tokens remain at the server on behalf of a user; and
automatically downloading the one or more tokens purchased from the server at a time subsequent to purchase.

2. The method of claim 1, wherein automatically downloading occurs upon connecting to a network.

3. The method of claim 1, wherein purchasing the one or more tokens comprises purchasing the one or more tokens from a first terminal and automatically downloading comprises downloading at a second terminal.

4. The method of claim 3, wherein the first terminal comprises a land-line terminal and the second terminal comprises a mobile terminal.

5. The method of claim 1, wherein purchasing comprises using at least one of soft money or soft coins to purchase the content.

6. A method, comprising:
purchasing one or more tokens from a source of tokens;
receiving the one or more tokens from the source of tokens;
generating one or more copies of content;
using the one or more tokens against the value of the one or more copies of the content;
writing data, at a first terminal, corresponding to the one or more copies of content into the used one or more tokens; and
transferring, from the first terminal, the one or more copies of the content.

7. The method of claim 6, further comprising reporting the use of the one or more tokens.

8. The method of claim 6, wherein writing data comprises writing an identification of the one or more copies of content and an license identification of the one or more copies of content.

9. The method of claim 6, wherein transferring comprises a non-Internet based transfer.

10. The method of claim 6, further comprising receiving the one or more copies of the content.

11. The method of claim 10, further comprising executing the received one or more copies of content without accounting for payment of the one or more copies of content.

12. The method of claim 6, further comprising using the data written in the used one or more tokens to pay a third party for usage of the one or more copies of content.

13. The method of claim 6, wherein using further comprises decreasing a number of the one or more tokens based on a value of the content.

14. A method, comprising:
purchasing and downloading one or more tokens;
generating one or more copies of the content;
locking the one or more copies of content; and
transferring the one or more locked copies of content.

15. The method of claim 14, further comprising:
receiving the one or more locked copies of content; and
unlocking the one or more locked copies of content.

16. The method of claim 15, wherein unlocking comprising using the one or more tokens against a value of the one more content files.

17. The method of claim 16, further comprising:
writing data into the one or more tokens used, wherein the data corresponds to the one or more copies of the content; and
reporting the use of the one or more tokens.

18. The method of claim 14, wherein the transfer comprises a non-Internet based transfer.

19. A method, comprising:
purchasing one or more tokens;
downloading and storing the one or more tokens that have been purchased; and
transmitting the one or more tokens.

20. The method of claim 19, wherein transmitting comprises employing a first non-Internet based transmission.

21. The method of claim 20, further comprising:
receiving the one or more tokens that have been transmitted;
downloading content from the server;
using the received one or more tokens against the value of the downloaded content; and
transmitting the received one or more tokens.

22. The method of claim 21, wherein transmitting the received tokens comprises a second non-Internet based transmission.

23. A terminal, comprising:
a processing element configured to connect to a server and enable a user to purchase one or more tokens from the server while offline such that the one or more tokens remain at the server on behalf of a user for download at a time subsequent to purchase.

24. The terminal of claim 23, wherein the processing element is further configured to automatically download the one or more tokens once online.

25. A system comprising the terminal of claim 23 and a second terminal comprising a processing element configured to automatically download the one or more tokens upon connecting to a network.

26. The system of claim 25, wherein the first terminal comprises a mobile terminal and the second terminal comprises a land-line terminal.

27. A terminal, comprising:
a processing element configured to enable a user to purchase one or more tokens;
the processing element is further configured to download the one or more tokens, generate one or more copies of content, and use the one or more tokens against the value of the one or more copies of the content; and
the processing element is further configured to write data corresponding to the one or more copies of content into the used one or more tokens, and transfer the one or more copies of the content.

28. The terminal of claim 27, wherein the processing element is further configured to connect to the server and report to the server the use of the one or more tokens.

29. A terminal, comprising:
a processing element configured to enable a user to purchase and download one or more tokens;
wherein the processing element is further configured to generate one or more copies of content, lock the one or more copies of content and transfer the one or more locked copies of content.

30. The terminal of claim 29, wherein the processing element is further configured to transfer the one or more locked copies of content such that another device is capable of unlocking the one or more locked copies of content by using the one or more tokens against the value of the one or more copies of content.

31. A terminal, comprising:
a processing element configured to enable a user to purchase the one or more tokens; and
the processing element is further configured to download and store the one or more tokens that were purchased, and transmit the one or more tokens.

32. The terminal of claim 31, wherein the processing element is further configured to transfer the one or more tokens, such that another device is capable of receiving the one or more tokens and using the received one or more tokens against the value of downloaded content.
